(19) United States
(12) Patent Application Publication
(10) Pub. No.: US 2007/0083910 A1
(43) Pub. Date: Apr. 12, 2007

(54) Method and system for seamless live broadcast of digital content

(76) Inventors: Anwar M. Haneef, Streamwood, IL (US); Jay R. Almaula, Bartlett, IL (US); Tzvetan T. Horozov, Hoffman Estates, IL (US); Jayanth P. Mysore, Streamwood, IL (US); Rajesh Sl Pazhyannur, Lake Zurich, IL (US); Venugopal Vasudevan, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/248,836

(22) Filed: Oct. 11, 2005

(51) Int. Cl. H04N 7/16; H04N 7/173

(52) U.S. Cl. 725/135; 725/136; 725/90

(57) ABSTRACT

A method and a system for live broadcast of digital content to a user switching between one or more electronic devices are provided. Each electronic device is connected to a network. The user makes a request to switch the live broadcast of the digital content from a first electronic device to one or more electronic devices in the network. The live broadcast of the digital content on the first electronic device is suspended based on the request from the user. The first electronic device informs at least one electronic device in the network to pre-emptively store the live broadcast of the digital content. The live broadcast of the digital content is then resumed on the one or more electronic devices, based on another request from the user.

### FIELD OF THE INVENTION

This invention generally relates to live broadcasting of digital content, and more specifically towards the seamless transmission of digital content across multiple devices.

### BACKGROUND OF THE INVENTION

With the increasing popularity of electronic devices, a large number of Digital Video Broadcast (DVB) enabled electronic devices have been introduced in the market. Examples of such devices include High Definition Television (HDTV), Digital Video Recorder (DVR), mobile phones, Personal Digital Assistants (PDA), and Video Cassette Recorder (VCR). These devices can be used to render live broadcast of digital content.

“Pause-resume” recording and playback allows a user to watch a live program while it is being recorded simultaneously. This enables the user to pause the content at any time instant, and resume the content therefrom, when required. While the recorded program is paused, the system continues to record the program in a buffer memory. The system keeps track of the time instant from which the user has paused a digital content, e.g. a live broadcast. The user can later resume the digital content from the same time instant. In this way, the user can pause and resume the broadcast of content on a particular electronic device.

However, in certain circumstances, the user might need to pause the live broadcast of a program from one electronic device and resume the playback from the same point on another electronic device. The synchronization of the digital content is maintained by a central server, which is connected to each electronic device.

It is therefore desirable to provide a method and a system with a seamless live broadcast pause-resume feature, where the live broadcast can be paused at a time instant from one electronic device, and resumed on another electronic device.

### BRIEF DESCRIPTION OF THE DRAWINGS

Various embodiments will hereinafter be described in conjunction with the appended drawings provided to illustrate and not to limit the invention, wherein like designations denote like elements, and in which:

FIG. 1 illustrates an exemplary environment in which various embodiments of the present invention can be practiced.

FIG. 2 illustrates an exemplary environment depicting the live broadcast of digital content to a user switching between one or more electronic devices, in accordance with an embodiment of the present invention.

FIG. 3 is a flowchart depicting a method for live broadcast of digital content to a user switching between one or more electronic devices, in accordance with one embodiment of the present invention.

FIG. 4 and FIG. 5 show a flowchart depicting a method for live broadcast of digital content to a user switching between one or more electronic devices, in accordance with another embodiment of the present invention.

FIG. 6 shows a block diagram of a system for live broadcast of digital content to a user switching between one or more electronic devices, in accordance with an embodiment of the present invention.

FIG. 7 shows a block diagram of a content switching unit, in accordance with an embodiment of the present invention.

FIG. 8 shows a block diagram of an informing unit, in accordance with an embodiment of the present invention.

FIG. 9 shows a block diagram of a resuming unit, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE EMBODIMENTS

Various embodiments of the present invention provide a method and a system for live broadcast of digital content to a user switching between one or more inter-connected electronic devices. The electronic devices can be inter-connected through a personal or a public network. The user switches the live broadcast from one electronic device to another electronic device. The switching involves suspending the live broadcast on an electronic device, and then resuming it on one or more electronic devices, depending on the request from the user. Each electronic device in the network is capable of rendering the live broadcast of the digital content.

Before describing in detail the method for switching the live broadcast of the digital content, it should be observed that the present invention resides primarily in the method steps and apparatus components, which are employed to achieve the live broadcast of the digital content to a user switching between the one or more electronic devices.

Accordingly, the method steps and apparatus components have been represented where appropriate by conventional symbols in the drawings, showing only those specific details that are pertinent to understanding the present invention, so as not to obscure the disclosure with details that will be readily apparent to those of ordinary skill in the art having the benefit of the description herein.

In this document, relational terms such as first and second, and so forth may be used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including” and/or “having”, as used herein, are defined as comprising.

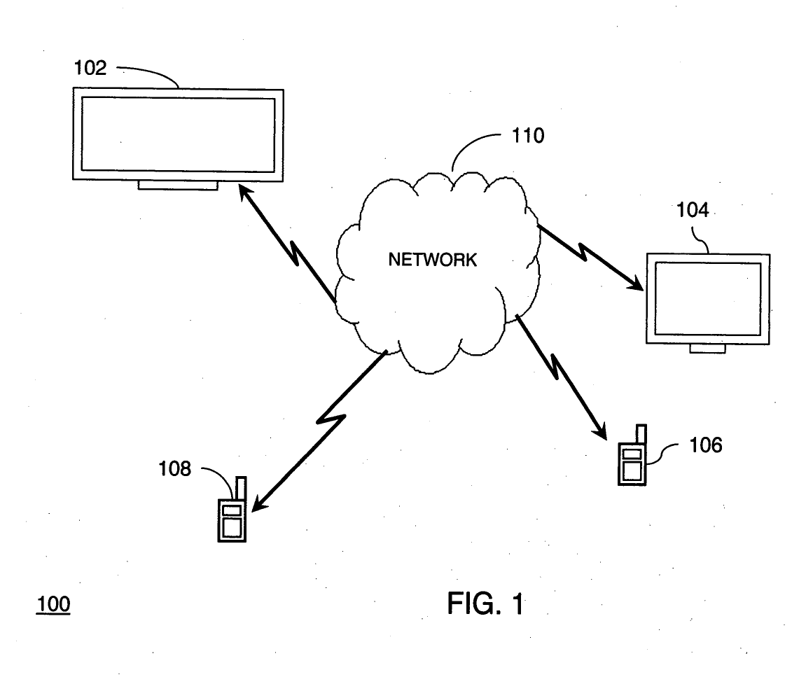

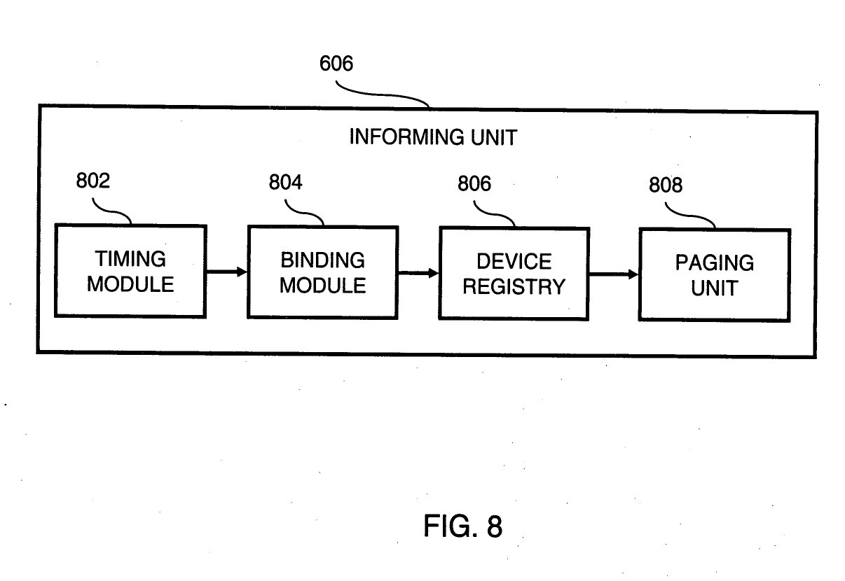

FIG. 1 illustrates an environment 100 wherein one or more electronic devices are inter-connected in a network, in accordance with an embodiment of the present invention. The environment 100 depicts electronic devices 102, 104, 106, and 108 being connected in the network 110. Exemplary electronic devices 102, 104, 106 and 108 include in-house Digital Video Recorders (DVRs), in-car DVRs, mobile handsets and Personal Digital Assistants (PDA). The network 110 can be an Ultra Wide Band (UWB) network, a Wi-Fi network, a Bluetooth network, an Infrared (IR) network, a Home RF network, a Local Area Network (LAN), a Wide Area Network (WAN) and so forth. The information related to the one or more electronic devices connected to the network 110 at any time instant can be stored in a device registry, which is explained later in conjunction with FIG. 8.

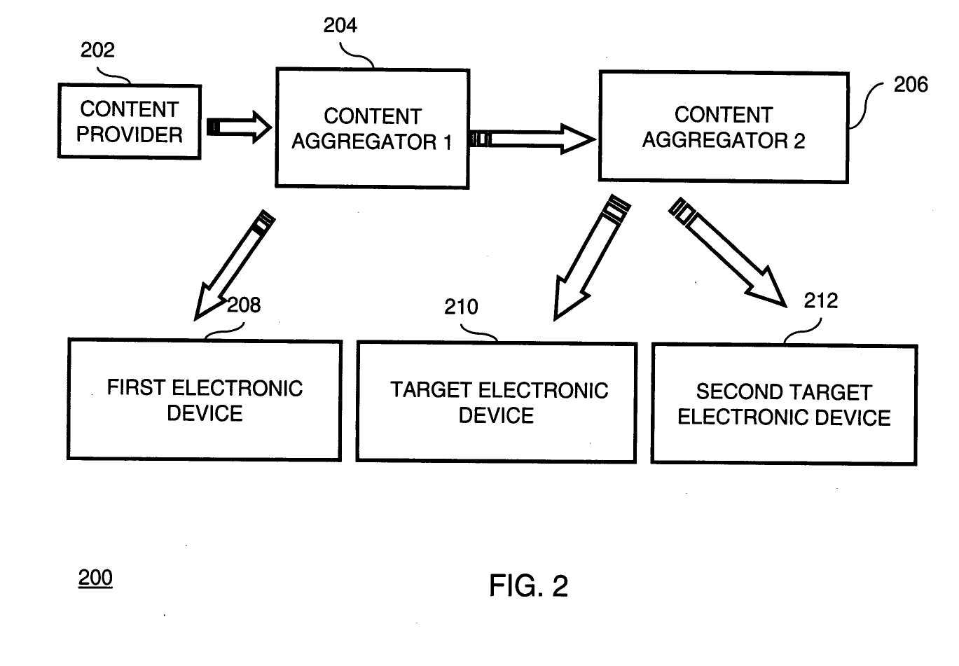

FIG. 2 illustrates an environment 200 depicting the live broadcast of the digital content to the user switching between one or more electronic devices, in accordance with an embodiment of the present invention. A content provider 202 provides the live broadcast of the digital content to a content aggregator 204 and a content aggregator 206. In accordance with an embodiment of the present invention, the digital content is the live broadcast to be viewed by the user. The content provider 202 distributes the digital content to content aggregators 204 and 206, via various distribution media such as a cable network, a satellite network, a terrestrial network and so forth. The content aggregators 204 and 206 process the digital content depending on the one or more electronic devices, with which they are associated, and provide the digital content to the respective electronic device.

The content aggregator 204 processes the digital content before sending the live broadcast of the digital content to a first electronic device 208. Examples of digital content processing by the content aggregator 204 include processing the digital content to a Motion Pictures Expert Group-2 (MPEG) stream, a High Definition Television (HDTV) stream and so forth. The first electronic device 208 records the live broadcast of the digital content while the user is watching the digital content. The content aggregator 206 further processes the digital signal before sending the live broadcast of the digital content to one or more target electronic devices.

Examples of the first electronic device and the target electronic device include an in-car DVR, an in-house DVR, a mobile handset, etc. In one embodiment, a multimedia capable handheld is used as a target device.

The target electronic device 210 receives the digital content from the content aggregator 206 when the user sends a request to switch from the first electronic device 208 to target electronic device 210. Similarly, the content aggregator 206 sends the digital content to a second target electronic device 212 when the user makes a new request to switch the live broadcast of the digital content from the target electronic device 210 to the second target electronic device 212. The switching of digital content across set of electronic devices is done in a manner to ensure a seamless transmission of the live broadcast.

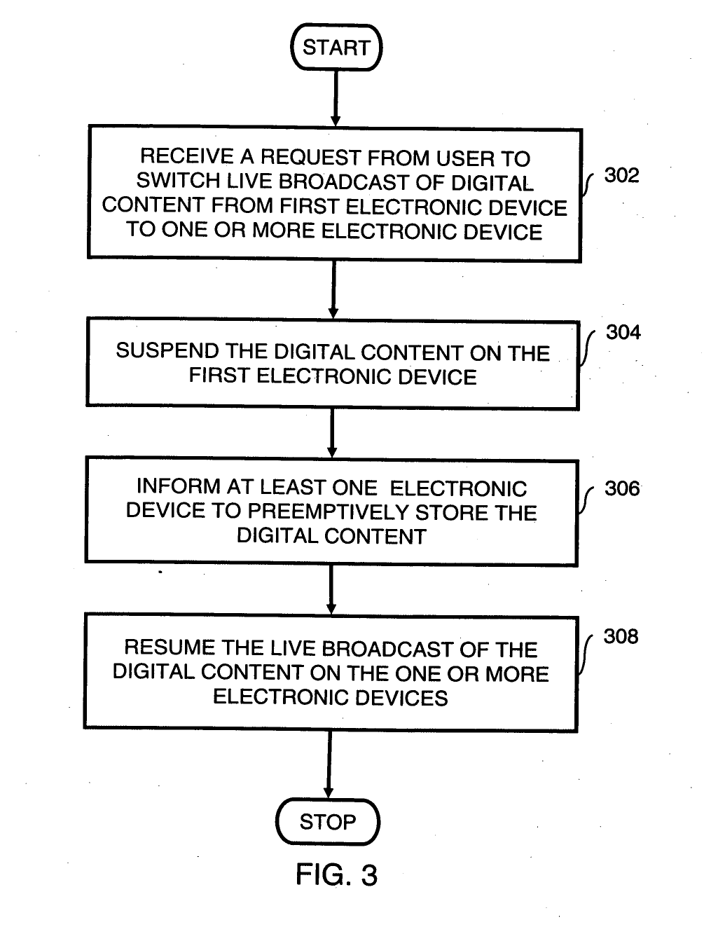

FIG. 3 is a flowchart depicting a method for delivering live broadcast of digital content to a user switching between one or more electronic devices, in accordance with one embodiment of the present invention. At step 302, the user makes a request to switch the live broadcast of the digital content from the first electronic device 208 to one or more target electronic devices. For example, the user requests to switch the digital content from the in-house DVR to the in-car DVR. At step 304, the live broadcast on the first electronic device 208 is suspended. At step 306, the first electronic device 208 informs at least one electronic device connected in the network to start storing the digital content. The digital content is stored in at least one electronic device for further retrieval on any target electronic device on which the user requests to resume the live broadcast.

At step 308, the live broadcast of the digital content is resumed on the one or more target electronic devices depending on the request from the user. The stored digital content is presented on the one or more target electronic devices to maintain a seamless live broadcast of the digital content for a user switching from the first electronic device 208 to the one or more target electronic devices.

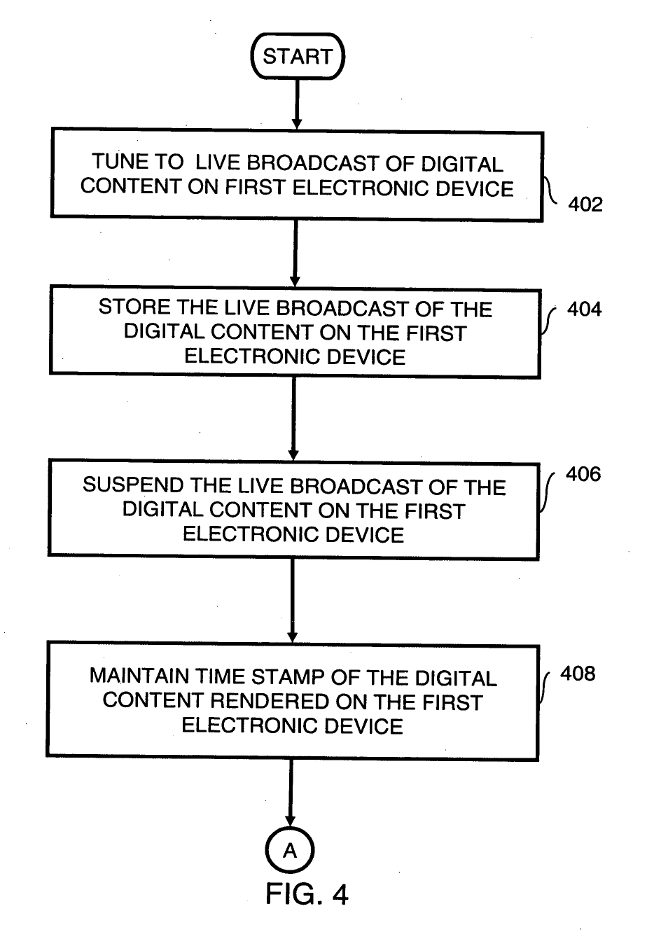

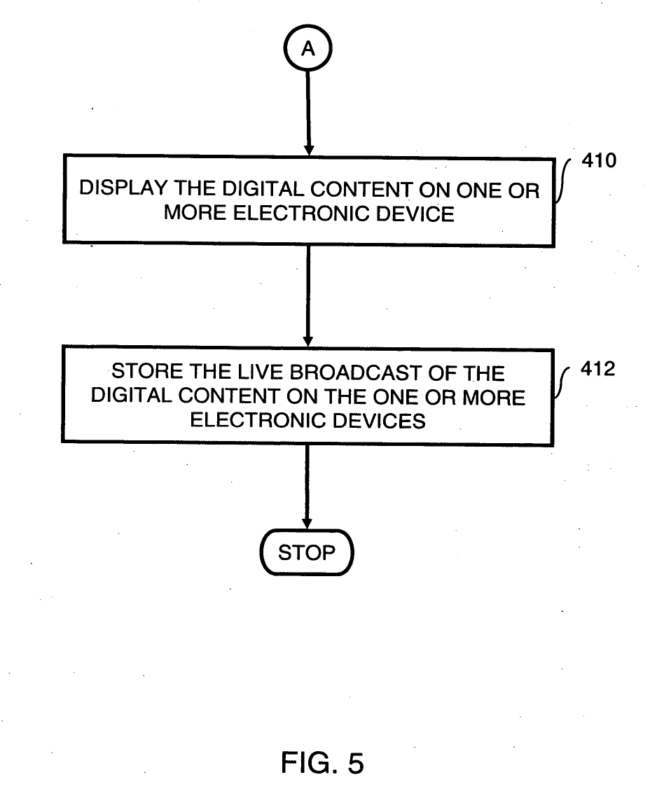

FIG. 4 and FIG. 5 show a flowchart depicting a method for live broadcast of digital content to a user switching between one or more electronic devices, in accordance with another embodiment of the present invention. At step 402, the live broadcast of the digital content is tuned to the first electronic device 208 based on a request from the user. At step 404, the first electronic device 208 stores the live broadcast of the digital content locally, i.e., the digital content is stored in a memory space in the first electronic device 208. For example, in case the first electronic device is an in-house DVR, it will store the digital content store in its local physical memory. It will be apparent to a user skilled in the art that the memory space can be inbuilt into the first electronic device 208, or attached to it externally.

At step 406, the user sends the request to the first electronic device 208 via a user interface to pause the live broadcast of the digital content. In various embodiments of the present invention, the user interface is a set of buttons on each electronic device, which enable a user to control the presentation of the digital content on the electronic devices. For example, the interface on the in-house DVR can be the set of buttons on the remote control of the in-house DVR, which help to control the presentation of the digital content.

At step 408, time stamp information of the digital content rendered on the first electronic device 208 is maintained. The time stamp information represents the time instant at which the user pauses the broadcast of the digital content on any electronic device. Further, the first electronic device 208 sends a start pre-emptive cache message to at least one target electronic device in the network, indicating to them to start storing the live broadcast. For example, the first electronic device which is the in-house DVR 208 sends the start pre-emptive cache message to the target electronic devices in-car DVR 210 and mobile handset 212 to start storing the digital content locally.

The start pre-emptive cache message includes time stamp and metadata information from the first electronic device. The metadata information describes the content, quality, condition, and other characteristics of the digital content. The other characteristics can comprise information regarding viewing preferences provided by the user, such as whether a digital content is to be rendered from the start of the live broadcast each time, i.e. whether it is preferentially aggregated or not. For example, a user might have set his/her preferences to resume the live broadcast from the start, even though the broadcast may be at any other point at a later time instant when it is paused.

At step 410, the user sends the request via the user interface, to the first target electronic device 210 to resume the live broadcast. For example, the user can resume the live broadcast on the in-car DVR 210. On resuming the live broadcast, the first target electronic device 210 sends a stop pre-emptive cache message to at least one target electronic device, to indicate to them that they should stop storing the digital content. For example, with reference to FIG. 2, the target electronic devices that received the stop pre-emptive cache message can include the in-house DVR and the mobile handset. The first target electronic device 210, which is the in-car DVR, starts rendering the stored digital content from the time instant the start pre-emptive cache message is received, while storing the live broadcast of the digital content locally.

At step 408, the first target electronic device 210 contacts the first electronic device 208 to obtain the digital content stored by the first electronic device 208 between the time instant at which the digital content is paused on the first electronic device 208, and the time instant at which the first target electronic device 210 received the start pre-emptive cache message. The digital content received from the first electronic device 208 and the digital content stored by the first target electronic device 210 based on the time stamp information, are subsequently sorted. This is done to ensure that the user can view a seamless live broadcast of the digital content from the point at which he/she instructed the first electronic device 208 to pause the live broadcast.

At step 412, the live broadcast of the digital content is stored on the first target electronic device 210, i.e., the digital content is stored in a memory space in the first target electronic device 210.

The user can further send a request, via the user interface, to pause the digital content being rendered on the first target electronic device 210 at a second time instant. The first target electronic device 210 sends the start pre-emptive cache message to at least one electronic device. On receiving the start pre-emptive cache message, the electronic devices start storing the digital content from the second time instant onwards. The user now sends the request to switch the live broadcast to a second target electronic device 212. For example, with reference to FIG. 2, the second target electronic device 212 can be a mobile handset.

The second target electronic device 212 then sends the stop pre-emptive cache message to at least one electronic device, to stop storing the digital content. The second target electronic device 212 also contacts the first target electronic device 210 to obtain the digital content stored by the first target electronic device 210 between the second time instant at which the digital content is paused, and the time instant at which the second target electronic device 212 received the start pre-emptive cache message. The digital content received from the first target electronic device 210 is sorted with the digital content being stored by the second target electronic device 212 based on the time stamp information. This further ensures that the user can view the seamless live broadcast of the digital content from the point at which he/she instructed the first target electronic device 210 to pause the live broadcast.

The second target electronic device 212 then starts rendering the stored digital content from the second time instant, while storing the live broadcast of the digital content locally.

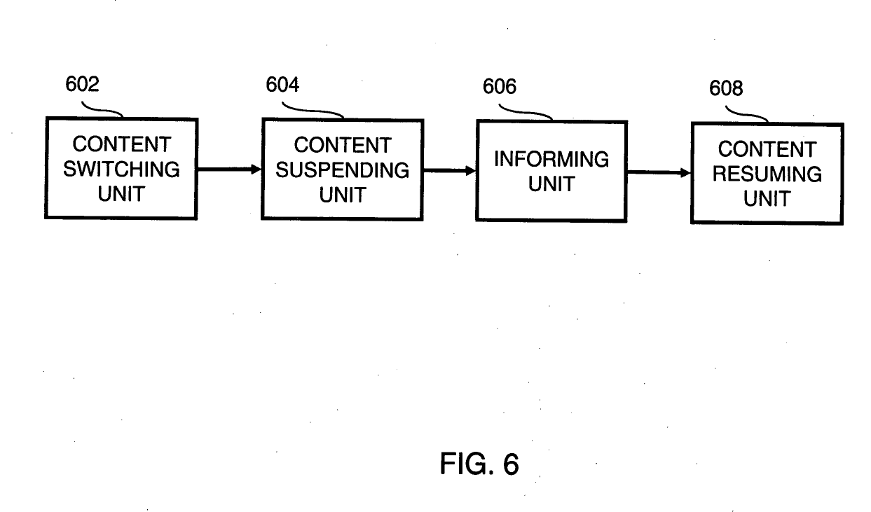

FIG. 6 shows a block diagram of a system for live broadcast of digital content to a user switching between one or more electronic devices, in accordance with an embodiment of the present invention. The system comprises a content switching unit 602, a content suspending unit 604, an informing unit 606 and a content resuming unit 608. The content switching unit 602 tunes the digital content on the one or more electronic devices, on receiving a request from the user. The content switching unit 602 is located in each electronic device.

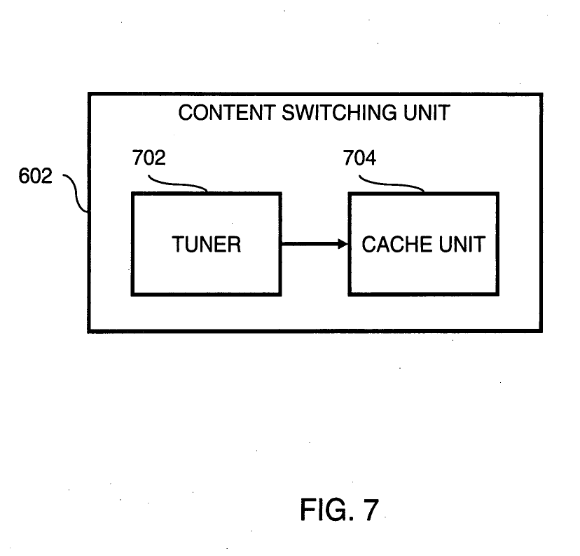

FIG. 7 shows a block diagram of the content switching unit 602, in accordance with an embodiment of the present invention. The content switching unit 602 includes a tuner 702 coupled with a cache unit 704. The tuner 702 tunes the live broadcast of the digital content on one or more electronic devices. In an exemplary embodiment of the present invention, the tuner 702 is a frequency tuner, which tunes to the frequency of the broadcast to present the digital content on the electronic device. The cache unit 704 stores the live broadcast being rendered on the one or more electronic devices. In accordance with an embodiment of the present invention, the cache unit 704 is embedded in each electronic device individually, and serves as a memory buffer for that electronic device.

Referring to FIG. 6, the content suspending unit 604 suspends the display of digital content on the one or more electronic devices, based on a request from the user. The content suspending unit 604 is located in each electronic device. In an exemplary embodiment of the present invention, the content suspending unit 604 is a ‘pause’ button on the electronic device such as the in-house DVR. The informing unit 606 informs at least one electronic device to pre-emptively store the live broadcast of the digital content by sending the start pre-emptive cache message. In an embodiment of the present invention, the informing unit 606 is located in each electronic device. The informing unit 606 is further described in conjunction with FIG. 8.

FIG. 8 shows a block diagram of the informing unit 606, in accordance with an embodiment of the present invention. The informing unit 606 includes a timing module 802, a binding module 804, a device registry 806, and a paging unit 808. The timing module 802 maintains the time stamp information of the digital content being rendered on the one or more electronic device, and provides the time stamp information to at least one electronic device in the network. In one embodiment of the present invention, the timing module 802 is a timer embedded in each electronic device, and its keeps a track of the time instant when the user requests the suspension or resumption of the live broadcast.

The binding module 804 extracts the metadata information of the digital content and provides the metadata information to at least one electronic device. The device registry unit 806 identifies at least one electronic device connected in the network and sends the information to the paging unit 808. The paging unit 808 informs at least one electronic device to start storing the digital content based on the time stamp information, by sending the start pre-emptive cache message.

In one embodiment of the present invention, the device registry 806 is implemented using a centralized architecture. In the centralized architecture, the device registry 806 is connected to each electronic device. The metadata and time stamp information is sent to at least one electronic device by the device registry 806. Further, on receiving the request from the user to pause the digital content, the first electronic device 208 contacts the device registry 806 to get a list of all the target electronic devices in the network.

In another embodiment of the present invention, the device registry 806 may be implemented using a distributed architecture. In the distributed architecture, the device registry 806 is coupled in at least one electronic device, i.e., as a bootstrap program entity. In an exemplary embodiment of the present invention a “LocoMOTv Agent”, which is a distributed, decentralized software entity, is coupled to at least one electronic device as a bootstrap program entity, and aids the inter-device interaction and distributed signaling for cache synchronization. For example, in the distributed architecture the first electronic device 208 contacts the device registry 806 in at least one electronic device for the metadata and time stamp information. Further, on receiving the time stamp and metadata information, the paging unit 808 informs at least one electronic device to start storing the digital content based on the time stamp information by sending the start pre-emptive cache message.

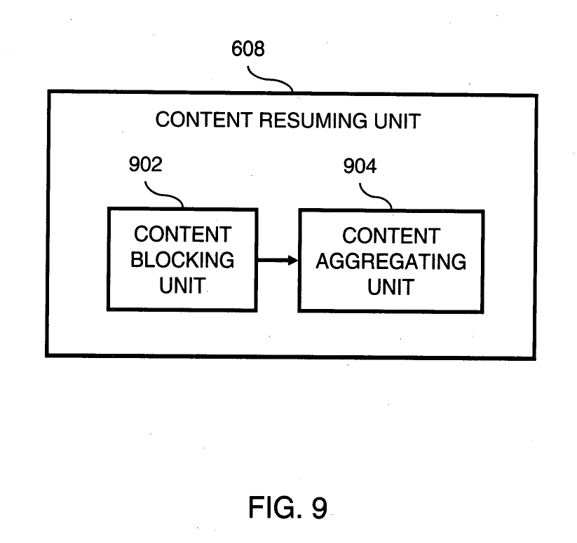

Referring to FIG. 6, on receiving a new request from the user, the content resuming unit 608 resumes the live broadcast of the digital content on the one or more electronic devices. FIG. 9 shows the block diagram of the resuming unit 608, in accordance with an embodiment of the present invention. The content resuming unit 608 includes a content blocking unit 902 and a content aggregating unit 904.

The content blocking unit 902 informs at least one electronic device to stop storing the digital content by sending the stop pre-emptive cache message to at least one electronic device, which received the start pre-emptive cache message. In one embodiment of the present invention, the content blocking unit 902 is a ‘hold’ button on the electronic device, which enables at least one electronic device to stop storing the digital content locally. The content aggregating unit 904 presents the digital content on one or more electronic devices by sorting the stored digital content and the live broadcast of the digital content. In one embodiment of the present invention, the content aggregating unit 904 is a digital combiner, which sorts the digital content received from the device on which the broadcast was presented and the device on which the broadcast is resumed, based on the time stamp information. This allows live broadcast to be presented when the user switches between one or more electronic devices.

The present invention provides a method and a system for live broadcast of digital content to a user switching between one or more interconnected electronic devices connected. The method allows the user to pause the live broadcast at any time instant from any electronic device and resume the live broadcast at any other time instant on another electronic device. This allows the user to switch the live broadcast across multiple electronic devices. The live broadcast is presented continuously even when the user has switched between the one or more electronic devices.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for live broadcast of digital content to a user switching between one or more electronic devices, each electronic device being connected to a network, the method comprising:
receiving a request from the user for switching the live broadcast of the digital content from a first electronic device to the one or more electronic devices;
suspending the live broadcast of the digital content on the first electronic device;
informing at least one electronic device in the network to preemptively store the live broadcast of the digital content; and
resuming the live broadcast of the digital content on the one or more electronic devices on which the broadcast of the digital content needs to be resumed, depending on the request from the user.

2. The method of claim 1, wherein receiving the request from the user comprising:
tuning to the live broadcast of the digital content on the first electronic device; and
storing the live broadcast of the digital content on the first electronic device.

3. The method of claim 1, wherein informing the at least one electronic device comprising:
maintaining a time stamp information of the digital content being rendered on the first electronic device, wherein the time stamp information represents the time instant at which live broadcast of the digital content needs to be suspended;
extracting metadata information of the digital content on the first electronic device, wherein the metadata information comprises parameters that describe the content, quality and condition characteristics of the digital content;
sending the metadata information to the at least one electronic device; and
sending the time stamp information of the digital content to the at least one electronic device.

4. The method of claim 3 further comprising:
locating the at least one electronic device by using a device registry information; and
informing the at least one electronic device to start storing the digital content based on the time stamp information.

5. The method of claim 3, wherein resuming the live broadcast of the digital content on the one of the one or more electronic devices comprising:
informing the at least one electronic device to stop storing the digital content;
receiving digital content being stored by the first electronic device based on the time stamp information;
presenting the digital content on the one or more electronic devices, wherein the digital content being stored by the first electronic device and the digital content being live broadcasted is sorted based on the time stamp information; and
storing the live broadcast of the digital content on the one or more electronic devices.

6. The method of claim 5, wherein presenting the digital content on the one of the one or more electronic device further comprising presenting a part of the digital content stored by the first electronic device based on information given by the user, the time stamp information, and the digital content.

7. A system for live broadcasting of digital content to a user switching between one or more electronic devices, each electronic device being connected to a network, the system comprising:
a content switching unit for switching the live broadcast of the digital content from a first electronic device to the one or more electronic devices;
a content suspending unit for suspending the live broadcast of the digital content on the first electronic device;
an informing unit for informing the at least one electronic device to preemptively store the live broadcast of the digital content; and
a content resuming unit for resuming the live broadcast of the digital content on the one or more electronic device depending on the request from the user.

8. The system of claim 7, wherein the content switching unit further comprises:
a tuner for tuning to the live broadcast of the digital content on the one or more electronic device; and
a cache unit for storing the live broadcast of the digital content on the one or more electronic device.

9. The system of claim 8, wherein the cache unit is coupled with the one or more electronic device.

10. The system of claim 7, wherein the informing unit further comprises:
a timing module for maintaining a time stamp information of the digital content being rendered on the first electronic device, and for providing the time stamp information to the at least one electronic device, wherein the time stamp information represents the time instant at which the broadcast of the digital content needs to be suspended; and
a binding module for extracting metadata information of the digital content on the first electronic device and providing the metadata information to the at least one electronic device, wherein the metadata information describes the content, quality, condition, and other characteristics of the digital content.

11. The system of claim 10 further comprising:
one or more device registry units for locating the at least one electronic device by using a device registry information; and
a paging unit for informing the at least one electronic device to start storing the digital content based on the time stamp information.

12. The system of claim 11, wherein the one or more device registry units are coupled to the one or more electronics devices.

13. The system of claim 10, wherein the resuming unit further comprises:
a content blocking unit informing the at least one electronic device to stop storing the digital content; and
a content aggregating unit for receiving digital content stored by the first electronic device based on the time stamp information, and presenting the live broadcast of the digital content on the one or more electronic devices.

14. The system of claim 13, wherein the content aggregating unit comprises a content appending unit for appending the digital content stored by the first electronic device to the live broadcast of the digital content.

15. The system of claim 7, wherein each electronic device is selected from a group consisting a Digital Video Recorder (DVR), a mobile, a computer, a Personal Digital Assistant (PDA), a laptop, a Video Cassette Recorder (VCR), and a video camera.

16. A method for live broadcast of digital content to a user switching between one or more electronic devices, each electronic device being connected to a network, the method comprising:
tuning to the live broadcast of the digital content on the first electronic device;
storing the live broadcast of the digital content on the first electronic device;
suspending the live broadcast of the digital content on the first electronic device;
maintaining a time stamp information of the digital content being rendered on the first electronic device, wherein the time stamp information represents the time instant at which live broadcast of the digital content needs to be suspended;
presenting the digital content on the one or more electronic devices, wherein the digital content being stored by the first electronic device and the digital content being live broadcasted is sorted based on the time stamp information; and
storing the live broadcast of the digital content on the one or more electronic devices.

17. The method of claim 16 further comprising locating the at least one electronic device by using a device registry information.

18. The method of claim 16 further comprising extracting metadata information of the digital content on the first electronic device, wherein the metadata information comprises parameters that describe the content, quality and condition characteristics of the digital content.

19. The method of claim 16 further comprising:
informing the at least one electronic device to start storing the digital content based on the time stamp information; and
informing the at least one electronic device to stop storing the digital content.

20. The method of claim 16, wherein presenting the digital content on the one of the one or more electronic device further comprising presenting a part of the digital content stored by the first electronic device based on information given by the user, the time stamp information, and the digital content.
